(19) United States
(12) Patent Application Publication
(10) Pub. No.: US 2013/0319480 A1
(43) Pub. Date: Dec. 5, 2013

(54) CLEANING DEVICE

(71) Applicant: HON HAI PRECISION INDUSTRY CO., LTD., New Taipei (TW)

(72) Inventors: MING-LU YANG, New Taipei (TW); XIAO-XING REN, Shenzhen (CN)

(73) Assignee: HON HAI PRECISION INDUSTRY CO., LTD., New Taipei (TW)

(21) Appl. No.: 13/902,956

(22) Filed: May 27, 2013

(30) Foreign Application Priority Data
Jun. 1, 2012 (CN) 201220255260X

(51) Int. Cl. B08B 3/04

(52) U.S. Cl. CPC B08B 3/041
USPC 134/95.2

(57) ABSTRACT

A cleaning device comprises a cleaning mechanism, a drying mechanism, and a transferring mechanism. The cleaning mechanism comprises a first receiving case, at least one cleaning tank received in the first receiving case, a transferring assembly, and a plurality of pipes. The transferring assembly is positioned on the first receiving case and located above the cleaning tank. The pipes communicate with the cleaning tanks. The drying mechanism comprises a second receiving case, a transporting member, and a plurality of air blower. The second receiving case is located besides the first receiving case, and parallel to the first receiving case. The transporting member is mounted on the second receiving case. The air blower are mounted on the second receiving case, and communicate with the second receiving case. The transferring mechanism is positioned at an end of the first receiving case and the second receiving case, respectively.

### BACKGROUND

1. Technical Field

The present disclosure relates to cleaning devices, particularly to a cleaning device capable of cleaning and drying workpieces.

2. Description of Related Art

Workpieces are required to be cleaned after a surface treating process, such as sand blasting, spraying, and polishing, for example. A manual or a chain-type cleaning mechanism may be used to clean workpieces. However, the manually cleaning results in a lowered cleaning efficiency, and it is not suitable for cleaning a larger volume of workpieces. The chain-type cleaning mechanism is welded in a workplace, and thus it is not easy to be transported to other locations.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a cleaning device.

FIG. 2 is an enlarged, isometric view of a circled portion II in FIG. 1.

FIG. 3 is an enlarged, isometric view of a circled portion III in FIG. 1.

### DETAILED DESCRIPTION

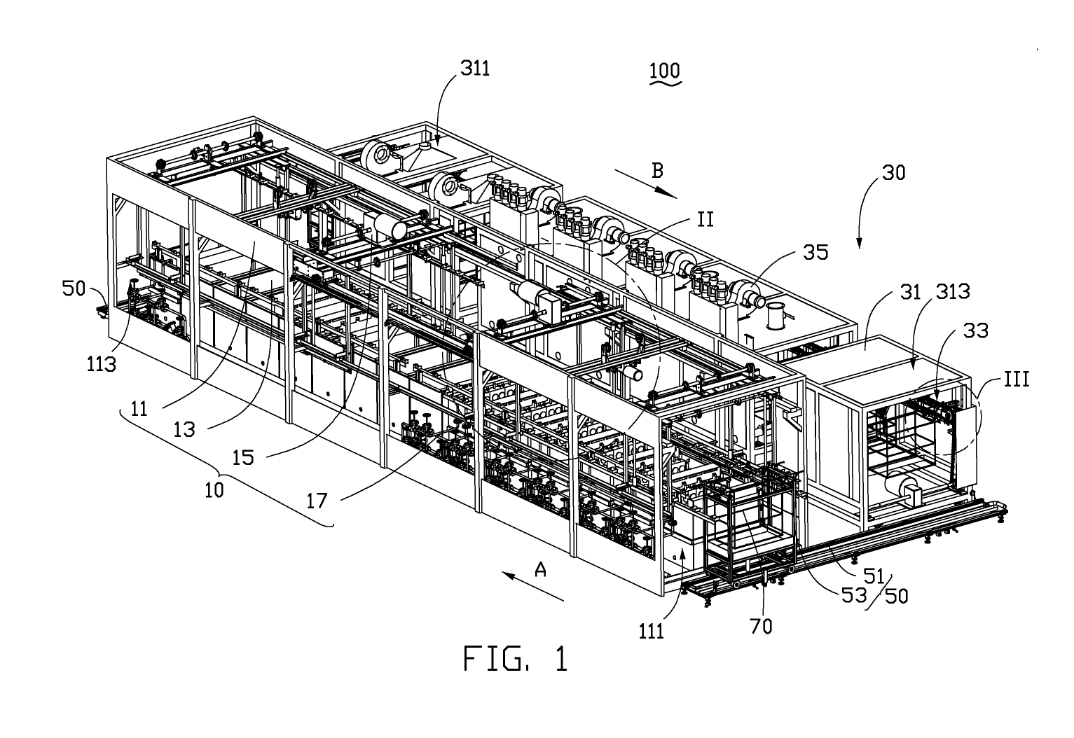

FIGS. 1 shows a cleaning device 100 of the embodiment. The cleaning device 100 includes a cleaning mechanism 10, a drying mechanism 30, a pair of transferring mechanisms 50, and at least one carrying frame 70. The cleaning mechanism 10 is located at a side of the drying mechanism 30, and parallel to the drying mechanism 30. The carrying frame 70 is configured for carrying workpieces (not shown), and is configured to be hung and transferred in the cleaning mechanism 10, the drying mechanism 30, and the transferring mechanism 50. The cleaning mechanism 10 is configured to clean workpieces carried by the carrying frame 70. The drying mechanism 30 is configured to dry workpieces carried by the carrying frame 70. The transferring mechanisms 50 are positioned at two opposite sides of the cleaning mechanism 10 and the drying mechanism 30. Each transferring mechanism 50 connects an end of the cleaning mechanism 10 and an adjacent end of the drying mechanism 30, for transferring workpieces carried by the carrying frame 70 from the end of the cleaning mechanism 10 to the adjacent end of the drying mechanism 30.

The cleaning mechanism 10 includes a first receiving case 11, a plurality of cleaning tanks 13, at least one transferring assembly 15, and a plurality of pipes 17. The first receiving case 11 is substantially cubic, and is provided as a supporting body and a housing, for assembling or disassembling the cleaning mechanism 10 conveniently. The first receiving case 11 includes a cleaning beginning end 111 and a cleaning finishing end 113. The cleaning beginning end 111 is the end of the first receiving case 11 where the workpieces are cleaned earliest. The cleaning finishing end 113 is the opposite end of the first receiving case 11 where the workpieces are cleaned last. A direction from the cleaning beginning end 111 to the cleaning finishing end 113 is defined as a direction A. The cleaning tanks 13 are received in the first receiving case 11, and supported by the first receiving case 11. The cleaning tanks 13 are configured to be filled with cleaning solution of different types. According to the cleaning needs for different workpieces, the number of the cleaning tanks 13 and chemical agents in the cleaning solution in the cleaning tanks 13 may be changed accordingly. The at least one transferring assembly 15 is hung on the first receiving case 11, and is located above the cleaning tanks 13. The at least one transferring assembly 15 is configured to hang the carrying frame 70, and transfer the carrying frame 70 and workpieces carried by the carrying frame 70 along the direction A, and is also configured to place the workpieces into the cleaning tanks 13 and pick up or retrieve from the cleaning tanks 13, for cleaning workpieces. In the illustrated embodiment, there are two transferring assemblies 15. The first receiving case 11 is a container, and a top cover and sidewalls thereof are not shown for the sake of clearly showing the cleaning tanks 13, the transferring assemblies 15 and the plurality of pipes 17.

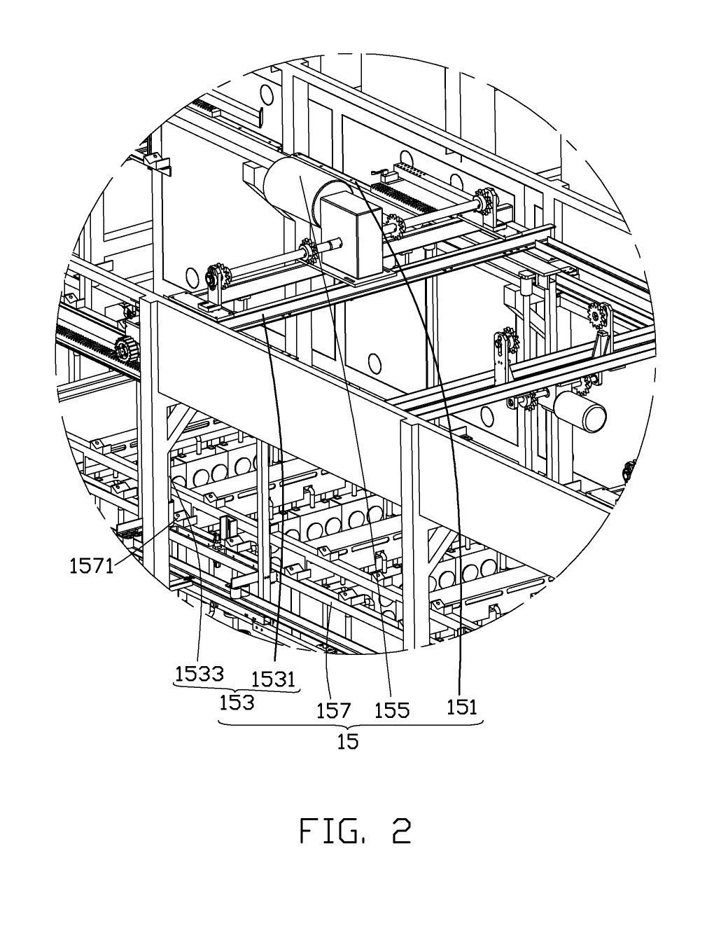

FIG. 2 shows the transferring assembly 15 including a pair of transferring rail 151, a mounting member 153, a driving member 155, and a pair of hanging members 157. The transferring rails 151 are positioned on a substantially top portion of the first receiving case 11 along the direction A, and are configured parallel to each other. The transferring rails 151 are located above the cleaning tanks 13. The mounting member 153 includes a mounting portion 1531 and a pair of extending portions 1533. Two ends of the mounting portion 1531 are slidably mounted on the transferring rails 151, respectively. The pair of extending portions 1533 perpendicularly extend from the two ends of the mounting portion 1531 towards the cleaning tanks 13, respectively. The driving member 155 is mounted on the mounting portion 1531, for driving the mounting portion 1531 to slide along the transferring rails 151 and for driving the extending portions 1533 to extend vertically.

Each of the hanging members 157 is mounted at a distal end of the corresponding extending portion 1533 away from the mounting portion 1531. The hanging members 157 are perpendicular to the extending portions 1533, for hanging the carrying frame 70. A plurality of positioning portions 1571 are formed on each hanging member 157, and are arranged apart. A top surface of each of the positioning portions 1571 is substantially V-shaped, for positioning the carrying frame 70 when hanging the carrying frame 70. The driving member 155 is capable of driving the extending portions 1533 to extend vertically, which results in having the hanging members 157 being transported vertically, and the workpieces hung on the hanging members 157 are thereby placed into the cleaning tanks 13 or picked up or retrieved from the cleaning tanks 13. In the illustrated embodiment, the transferring assembly 15 is a travelling crane. In alternative embodiments, the number of the transferring assembly 15 may be one, three or more than three, and a cleaning efficiency may be changed correspondingly.

The plurality of pipes 17 are received in the first receiving case 11, and are communicated with the cleaning tanks 13, for guiding cleaning solution into the cleaning tanks 13.

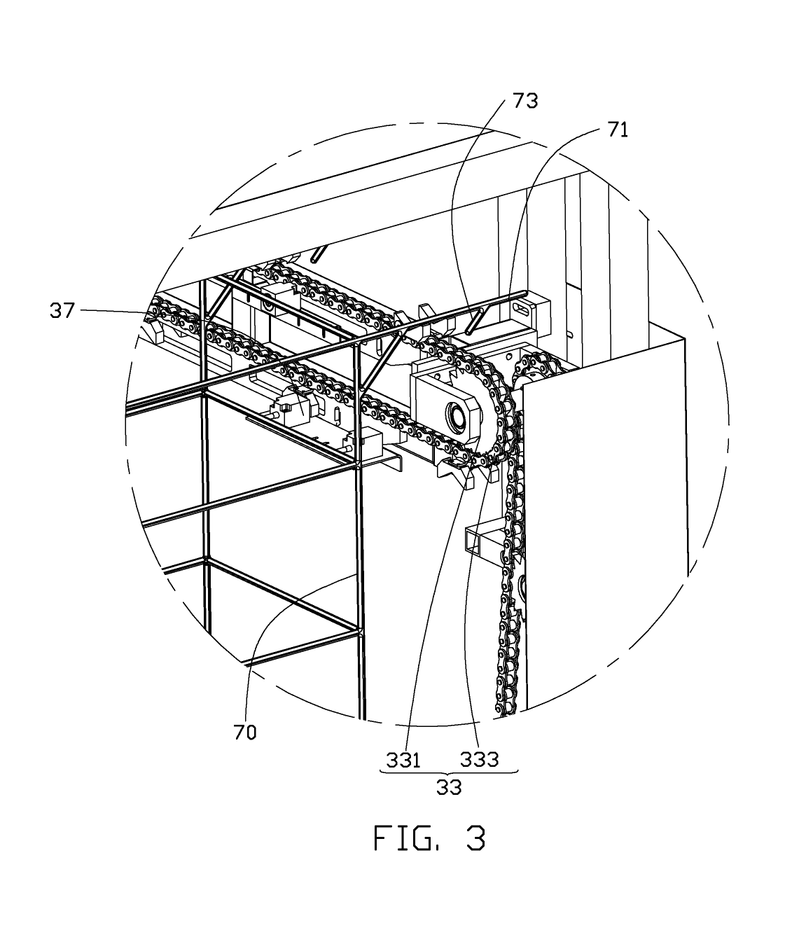

FIGS. 1 and 3 show the drying mechanism 30 positioned parallel to the first receiving case 11 of the cleaning mechanism 10. The drying mechanism 30 includes a second receiving case 31, a transporting member 33, a plurality of air blower 35, and a heater 37. The second receiving case 31 is substantially cubic, and is provided as a supporting body and a housing, for assembling or disassembling the drying mechanism 30 conveniently. The second receiving case 31 is positioned parallel to the first receiving case 11. The second receiving case 31 includes a drying beginning end 311 and a drying finishing end 313. The drying beginning end 311 is the end of the second receiving case 31 where the workpieces are dried earliest, and the drying finishing end 313 is the opposite end of the second receiving case 31 where the workpieces are dried last. A direction from the drying beginning end 311 to the drying finishing end 313 is defined as a direction B. The drying beginning end 311 of the second receiving case 31 is located adjacent to the cleaning finishing end 113 of the first receiving case 11. The drying finishing end 313 of the second receiving case 31 is located adjacent to the cleaning beginning end 111 of the first receiving case 11. The direction B is parallel and opposite to the direction A.

The transporting member 33 is mounted on the second receiving case 31, and is received in the second receiving case 31, for transporting the carrying frame 70 and workpieces received in the carrying frame 70 along the direction B. The transporting member 33 includes a pair of driving gears 331 and a transporting chain 333 meshing with the driving gears 331. The driving gears 331 are rotatably mounted on two ends of the second receiving case 31. The transporting chain 333 winds on the driving gears 331, and is positioned along the direction B, for hanging the carrying frame 70. When the driving gears 331 are rotated, the transporting chain 333 moves along the direction B, thus the carrying frame 70 and workpieces received in the carrying frame 70 are transported from the drying beginning end 311 to the drying finishing end 313 of the second receiving case 31.

The air blower 35 communicate with the second receiving case 31, and is capable of producing high pressure air into the second receiving case 31, for high-pressure dehydration of the workpieces. The heater 37 is received in an end of the second receiving case 31 adjacent to the drying finishing end 313, for drying the workpieces after high-pressure dehydrating by the high pressure air produced by the air blower 35. In the illustrated embodiment, the second receiving case 31 is a container.

Each transferring mechanism 50 includes a guiding member 51 and a conveyer 53 slidably mounted on the guiding member 51. The guiding member 51 of one transferring mechanism 50 extends from the drying finishing end 313 of the second receiving case 31 to the cleaning beginning end 111 of the first receiving case 11, thereby having the conveyer 53 moving from the drying finishing end 313 of the second receiving case 31 to the cleaning beginning end 111 of the first receiving case 11 along the guiding member 51. The guiding member 51 of another transferring mechanism 50 extends from the cleaning finishing end 113 of the first receiving case 11 to the drying beginning end 311 of the second receiving case 31, thereby having the conveyer 53 moving from the cleaning finishing end 113 of the first receiving case 11 to the drying beginning end 311 of the second receiving case 31 along the guiding member 51. In the illustrated embodiment, the guiding member 51 is a guiding rail. The conveyer 53 is substantially a cubic frame, for hanging the carrying frame 70, and thereby conveying the workpieces received in the carrying frame 70.

The carrying frame 70 is substantially a rectangular frame, and forms a plurality of hanging ends 71 at opposite sides thereof. A latching portion 73 protrudes from each of the hanging ends 71. The workpieces are placed on the carrying frame 70, and then the hanging ends 71 are hung on the conveyer 53, the hanging members 157 of the cleaning mechanism 10, or the transporting chain 333 of the drying mechanism 30, and the latching portion 73 accordingly latches, the hanging members 157, or the transporting chain 333 with the conveyer 53.

The cleaning device 100 may further comprise two feeding mechanisms (not shown) and two laying-out mechanisms (not shown). The feeding mechanisms are positioned adjacent to the cleaning beginning end 111 and the drying beginning end 311, respectively. The laying-out mechanisms are positioned adjacent to the cleaning finishing end 113 and the drying finishing end 313, respectively. The feeding mechanisms are configured for grasping the carrying frame 70 hung on the conveyer 53 to hang on the hanging members 157, or grasping the carrying frame 70 hung on the conveyer 53 of another transferring mechanism 50 to be hung on the transporting chain 333. In the illustrated embodiment, the feeding mechanisms and laying-out mechanisms are robot arms.

In assembly, first, the cleaning tanks 13 are assembled in the first receiving case 11. The pipes 17 are mounted on the first receiving case 11, and communicated with the cleaning tanks 13, and guide cleaning solution to the cleaning tanks 13. The transferring rails 151 are positioned on the first receiving case 11. The mounting member 153 is positioned on the transferring rails 151. The driving member 155 is located on the mounting portion 1531 of the mounting member 153. The hanging members 157 are perpendicularly positioned on the extending portions 1533, respectively. Second, the second receiving case 31 is parallelly positioned besides the first receiving case 11, and is parallel to the first receiving case 11. The driving gears 331 are positioned at opposite ends of the second receiving case 31. The transporting chain 333 is wound around on the driving gears 331. The air blower 35 are mounted on the second receiving case 31, and produces high pressure air to the second receiving case 31. The heater 37 is positioned in the end of the second receiving case 31 adjacent to the drying finishing end 313. Third, the guiding member 51 are positioned at opposite ends of the first receiving case 11 and the second receiving case 31. The conveyers 53 are located on the corresponding guiding member 51. The feeding mechanisms and the laying-out mechanisms are respectively positioned at two opposite ends of the first receiving case 11 and two opposite ends of the second receiving case 31.

In use, an operator or the feeding mechanism grasps the carrying frame 70 receiving unclean workpieces from the conveyer 53 adjacent to the cleaning beginning end 111 to hang on the hanging member 157 of the cleaning mechanism 10. The driving member 155 drives the hanging members 157 via the mounting member 153 to move along the transferring rails 151 in the direction A. When the carrying frame 70 is transferred above the cleaning tanks 13, the driving member 155 stops driving the mounting member 153 to move along the transferring rails 151, and starts driving the extending portions 1533 to extend vertically, thereby having the carrying frame 70 being put into the cleaning tank 13 for cleaning workpieces. After the workpieces are cleaned, the driving member 155 extends the extending portions 1533 to pick up the workpieces from the cleaning tanks 13, and continues to move the mounting member 153 along the transferring rails 151. After cleaning the workpieces, the carrying frame 70 hung on the hanging members 157 are taken out by the operator or the laying-out mechanism, and the carrying frame 70 is hung on the conveyer 53. The conveyer 53 transports the carrying frame 70 and the workpieces received therein along the guiding member 51 from the cleaning finishing end 113 to the drying beginning end 311. Operator or the feeding mechanism grasps the carrying frame 70 to hang on the transporting chain 333. The driving gears 331 drives the transporting chain 333 and the carrying frame 70 along the direction B from the drying beginning end 311 to the drying finishing end 313. The workpieces received in the carrying frame 70 are dehydrated under high-pressure by the high-pressure air produced by the air blower 35, and then dried by the heater 37. After the workpieces are dried, operator or the laying-off mechanism takes the carrying frame 70 out from the transporting chain 333 to hang on the conveyer 53. The workpieces being dried are transported or carried to other processes. The empty carrying frame 70 is transported to the end of the guiding member 51 adjacent to the cleaning beginning end 111 of the first receiving case 11, for carrying other workpieces for cleaning.

In an alternative embodiment, the number of the transferring mechanism may be one, and the transferring mechanism is located besides the cleaning finishing end 113 of the first receiving case 11 and the drying beginning end 311 of the second receiving case 31. The heater 37 may be omitted when the workpieces are capable of drying by the high pressure air produced by the air blower 35.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A cleaning device, for cleaning and drying workpieces, comprising:
a cleaning mechanism comprising:
a first receiving case;
at least one cleaning tank received in the first receiving case;
a transferring assembly positioned on the first receiving case and located above the at least one cleaning tank, for transporting the workpieces from an end of the first receiving case to an opposite end of the first receiving case, and for placing the workpieces into the at least one cleaning tank and picking up the workpieces from the at least one cleaning tank; and
a plurality of pipes communicating with the at least one cleaning tank, for guiding cleaning solution into the at least one cleaning tank; and
a drying mechanism comprising:
a second receiving case located besides the first receiving case;
a transporting member mounted on the second receiving case, for transporting the workpieces after cleaning by the cleaning mechanism from an end of the second receiving case to an opposite end of the second receiving case;
a plurality of air blower mounted on the second receiving case, and communicated with the second receiving case, for producing high pressure air to the second receiving case, and thereby dehydrating the workpieces under high-pressure air; and
a heater received in the second receiving case, for drying the workpieces after high-pressure dehydrating by the high pressure air produced by the air blower.

2. The cleaning device of claim 1, wherein the first receiving case comprising a cleaning beginning end and a cleaning finishing end, the cleaning beginning end is the end of the first receiving case where the workpieces are cleaned earliest, and the cleaning finishing end is the opposite end of the first receiving case where the workpieces are cleaned last, the second receiving case comprising a drying beginning end, and a drying finishing end, the drying beginning end is the end of the second receiving case where the workpieces are dried earliest, and the drying finishing end is the opposite end of the second receiving case where the workpieces are dried last, the cleaning finishing end of the first receiving case is located adjacent to the drying beginning end of the second receiving case.

3. The cleaning device of claim 2, wherein a transferring mechanism is positioned besides the drying beginning end of the second receiving case and the cleaning finishing end of the first receiving case, the transferring mechanism is capable of transferring the workpieces from the cleaning finishing end of the first receiving case to the drying beginning end of the second receiving case.

4. The cleaning device of claim 3, wherein the transferring mechanism comprises a guiding member and a conveyer slidably mounted on the guiding member, the guiding member extends from the cleaning finishing end of the first receiving case to the drying beginning end of the second receiving case, thus the conveyer is capable of moving from the cleaning finishing end of the first receiving case to the drying beginning end of the second receiving case along the guiding member.

5. The cleaning device of claim 2, wherein the transferring assembly comprises a pair of transferring rails, a mounting member, a driving member, and a pair of hanging members, the pair of transferring rails is positioned on the first receiving case, and is located above the at least one cleaning tanks, the mounting member is mounted on the pair of transferring rails, the driving member is positioned on the mounting member, the pair of hanging member is positioned on the mounting member, for hanging workpieces, the driving member is capable of driving the mounting member to move along the pair of transferring rail, and driving the mounting member to extend vertically, thereby capable of transporting the workpieces hung on the hanging member from the cleaning beginning end to the cleaning finishing end, and transporting the workpieces into the at least one cleaning tank.

6. The cleaning device of claim 5, wherein the mounting member comprises a mounting portion and a pair of extending portions, two ends of the mounting portion are slidably mounted on the pair of transferring rails, respectively, the pair of extending portions perpendicularly extends from the two ends of the mounting portion towards the at least one cleaning tank, respectively, the driving member is mounted on the mounting portion, each of the pair of hanging members is mounted on an end of the corresponding extending portion away from the mounting portion.

7. The cleaning device of claim 1, wherein the transferring assembly is a travelling crane.

8. The cleaning device of claim 1, wherein the first receiving case and the second receiving case are containers.

9. The cleaning device of claim 2, wherein the transporting member comprises a pair of driving gears and a transporting chain meshing with the pair of driving gears, the pair of driving gears is rotatably mounted on the drying beginning end and the drying finishing end of the second receiving case, the transporting chain winds on the pair of driving gears.

10. The cleaning device of claim 2, wherein the cleaning beginning end of the first receiving case is located adjacent to the drying finishing end of the second receiving case, a transferring mechanism is positioned besides the drying finishing end of the second receiving case and the cleaning beginning end of the first receiving case.

11. The cleaning device of claim 1, wherein the cleaning device further comprises at least one carrying frame, for hanging workpieces, the carrying frame is capable of being hung on the transferring assembly or the transporting member.

12. The cleaning device of claim 11, wherein the at least one carrying frame forms two hanging ends at opposite sides thereof, a latching portion protrudes from each of the hanging ends.

13. A cleaning device, for cleaning and drying workpieces, comprising:
a cleaning mechanism comprising:
a first receiving case;
at least one cleaning tank received in the first receiving case;
a transferring assembly positioned on the first receiving case and located above the at least one cleaning tank, for transporting the workpieces from an end of the first receiving case to an opposite end of the first receiving case, and for placing the workpieces into the at least one cleaning tank and picking up the workpieces from the at least one cleaning tank; and
a plurality of pipes communicating with the at least one cleaning tank, for guiding cleaning solution into the at least one cleaning tank, and
a drying mechanism comprising:
a second receiving case located besides the first receiving case, and parallel to the first receiving case;
a transporting member mounted on the second receiving case, for transporting workpieces after cleaning by the cleaning mechanism from an end of the second receiving case to an opposite end of the second receiving case; and
a plurality of air blower mounted on the second receiving case, and communicating with the second receiving case, for guiding high pressure air to the second receiving case, thereby dehydrating the workpieces under high-pressure air, and
a transferring mechanism positioned at an end of the first receiving case and at an end of the second receiving case, for transferring workpieces from the end of the first receiving case to the end of the second receiving case.

14. The cleaning device of claim 13, wherein the transferring mechanism comprises a guiding member and a conveyer slidably mounted on the guiding member, the guiding member extends from the end of the first receiving case to the end of the second receiving case, thus the conveyer is capable of moving from the end of the first receiving case to the end of the second receiving case.

15. The cleaning device of claim 13, wherein the transferring assembly comprises a pair of transferring rails, a mounting member, a driving member, and a pair of hanging members, the pair of transferring rails is positioned on the first receiving case, and is located above the at least one cleaning tanks, the mounting member is mounted on the pair of transferring rails, the driving member is positioned on the mounting member, the hanging members are positioned on the mounting member, for hanging workpieces, the driving member is capable of driving the mounting member to move along the pair of transferring rails, and driving the mounting member to extend vertically.

16. The cleaning device of claim 15, wherein the mounting member comprises a mounting portion and a pair of extending portions, two ends of the mounting portion are slidably mounted on the pair of transferring rails, respectively, the pair of extending portions perpendicularly extends from the two ends of the mounting portion towards the at least one cleaning tank, respectively, the driving member is mounted on the mounting portion, each of the pair of the hanging members is mounted on an end of the corresponding extending portion away from the mounting portion.

17. The cleaning device of claim 13, wherein the first receiving case and the second receiving case are containers.

18. The cleaning device of claim 13, wherein the transporting member comprises a pair of driving gears and a transporting chain meshing with the pair of driving gears, the pair of driving gears is rotatably mounted on two ends of the second receiving case, the transporting chain winds on the pair of driving gears, for transporting workpieces, the driving gears are rotated, the transporting chain are thereby moving along the second receiving case.

19. The cleaning device of claim 1, wherein the cleaning device further comprises at least one carrying frame, for hanging workpieces, the carrying frame is capable of being hung on the transferring assembly or the transporting member.

20. The cleaning device of claim 19, wherein the carrying frame forms two hanging ends at opposite sides thereof, a latching portion protrudes from each of the hanging ends.
